(19) United States
(12) Patent Application Publication
(10) Pub. No.: US 2021/0171361 A1
(43) Pub. Date: Jun. 10, 2021

(54) METHODS, DEVICES AND SYSTEMS FOR SUSPENDED SOLIDS REMOVAL

(71) Applicant: STORMWATERX, LLC, Portland, OR (US)

(72) Inventors: Robert CHAPLER, Portland, OR (US); Theodore LATHROP, Portland, OR (US)

(73) Assignee: STORMWATERX, LLC, Portland, OR (US)

(21) Appl. No.: 17/114,811

(22) Filed: Dec. 8, 2020

Related U.S. Application Data
(60) Provisional application No. 62/946,327, filed on Dec. 10, 2019.

(51) Int. Cl. C02F 1/00; B01D 29/56; B01D 17/04

(52) U.S. Cl. CPC C02F 1/004; C02F 2103/001; B01D 17/045; B01D 29/56

(57) ABSTRACT

Disclosed are devices, systems and methods for treatment or pre-treatment of stormwater which can provide a high-rate stormwater filtration that is suitable for sites with high particulates (total suspended solid (TSS)) loading.

### CROSS-REFERENCE

This application claims the benefit of U.S. Provisional Application No. 62/946,327, filed Dec. 10, 2019, entitled UNDERGROUND PASSIVE MEDIA FILTER which application is incorporated herein in its entirety by reference.

### BACKGROUND

As the climate continues to change causing increased storm intensity, the impact of stormwater pollution continues to be an important environmental issue. Stormwater runoff has been identified as a leading cause of water quality impairment. Stormwater, whether from rain or snowmelt, picks-up and carries pollutants along its pathway into our waterways. The pollutants in stormwater can include: trash and floatables, hydrocarbons, oil and heavy metals from vehicles and emissions; nutrients such as nitrogen and phosphorus, pesticides and other chemicals; bacteria; and sediment.

A variety of solutions exist for stormwater pollution management. Stormwater pollution management practices are referred to as Best Management Practices (BMPs). BMPs can include source control, structural controls and treatment controls. Stormwater treatment systems, such as a gravity separator, can be used to remove dirt, oil and floatable material from stormwater. See, for example, U.S. Pat. No. 7,892,425 issued Feb. 22, 2011 for Stormwater Plug Flow Separation System. There are, however, limits to the amount and nature of materials that can easily be removed from stormwater using current solutions.

What is needed are passive and semi-passive devices, systems and methods for treatment or pre-treatment of stormwater which can provide efficient stormwater filtration. Additionally, what is needed are devices, systems and methods for treatment or pre-treatment of stormwater which is suitable for sites with high particulates (TSS) loading such as industrial facilities, multi-family residential and commercial facilities.

### SUMMARY

Disclosed are devices, systems and methods for treatment or pre-treatment of stormwater which can provide efficient stormwater filtration. Also disclosed are devices, systems and methods for treatment or pre-treatment of stormwater which is suitable for sites with high particulates (total suspended solid (TSS)), oil and floatables loading. Devices include a passive media filter that can operate by gravity with no power required and no mechanical or moving parts. Media can be formulated for high-flow and high sediment loading.

An aspect of the disclosure is directed to filtration systems. Filtration systems comprise a flow container wherein the flow container comprises: a fluid inlet aperture; an inlet chamber in fluid communication with the fluid inlet aperture; a first media filtration chamber in fluid communication with the inlet chamber having a first media; a flow structure positioned between the inlet chamber and the first media filtration chamber wherein the flow structure is configured to direct fluid passing from the inlet chamber to the first media filtration chamber in a downward direction; a second media filtration chamber in fluid communication with the first media filtration chamber having a second media wherein the second media filtration chamber has an upward treatment flow direction; a wide flow transfer window positioned between the first media filtration chamber and the second media filtration chamber wherein the wide flow transfer window allows continuous filtration between the first media filtration chamber and the second media filtration chamber; an outlet chamber in fluid communication with the second media filtration chamber; and an outlet aperture in fluid communication with the outlet chamber. In some configurations, the inlet chamber is further in fluid communication with the outlet chamber via an internal high-flow bypass. In still other configurations, the first media and the second media are the same media material. Additionally, a position of the flow structure between the inlet chamber and the first media filtration chamber is positioned above an upper level of the media layer. A position of the wide flow transfer window between the first media filtration chamber and the second media filtration chamber is positioned below an upper level of the media layer in the first media filtration chamber. In other configurations, the wide-flow transfer window is positioned along a lower surface of the chambers. The filtration system can further be positioned in series with a second treatment device, such as a pre-treatment system or a secondary treatment system. The systems are configurable to have a pollutant removal efficiency of at least one of: TSS 50-70%; Aluminum 30-60%; Copper 40-70%; Iron 40-60%; and Zinc 10-30%. Additionally, the systems are configurable to have a treatment rate of from 160 gallons-per-minute to 1,400 gallons-per-minute.

Other aspects of the disclosure are directed to methods of treating fluid comprising the steps of: providing a source fluid for treatment to an inlet chamber via at least one of a lateral inlet aperture and an upper aperture; transferring the fluid received into the inlet chamber to a first media filtration chamber via a flow structure positioned between the inlet chamber and the first media filtration chamber wherein the flow structure is configured to direct fluid passing from the inlet chamber to the first media filtration chamber in a downward direction; passing the fluid received into the first media filtration chamber through a first media layer; passing the fluid via a wide flow transfer window through a second media layer in a second media filtration chamber; receiving the fluid onto a surface of the second media layer; and passing fluid into an outlet chamber in fluid communication with the second media filtration chamber; and delivering fluid from the outlet chamber via an outlet aperture. The fluid received into the inlet chamber can be gravity fed. Additionally, the methods can include the step of passing the fluid from the inlet chamber to the outlet chamber when a fluid level exceeds a holding volume in the inlet chamber. Additionally, the first media layer and the second media layer comprise the same media material. Alternatively, the first media layer and the second media layer comprise the different media material. The methods can further comprising the step of removing pollutants from the fluid through one or more of mechanical filtration, media surface adhesion, and coalescing of oily substances. Fluid can also be through the media using a high surface area and low fluid velocity. Additionally, the filtration system can have a pollutant removal efficiency of at least one of: TSS 50-70%; Aluminum 30-60%; Copper 40-70%; Iron 40-60%; and Zinc 10-30% and/or configured to treat 160 to 1400 gallons per minute. The methods are suitable to process fluids that contain solid materials and particulate materials.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

U.S. Pat. No. 248,574 A dated 1881 Oct. 25 12:00 AM by Burkhardt;

U.S. Pat. No. 329,791 A dated Nov. 3, 1885 by Westinghouse;

U.S. Pat. No. 962,606 A dated Jun. 28, 1910 by Wiest;

U.S. Pat. No. 1,332,882 A dated Mar. 9, 1920 by Boze;

U.S. Pat. No. 1,422,674 A dated Jul. 11, 1922 by Cook;

U.S. Pat. No. 1,902,171 A dated Mar. 21, 1933 by Kopp;

U.S. Pat. No. 3,228,531 A dated Jan. 11, 1966 by Proudman;

U.S. Pat. No. 3,554,377 A dated Jan. 12, 1971 by Miller;

U.S. Pat. No. 4,208,291 A dated Jun. 17, 1980 by Ochoa;

U.S. Pat. No. 4,717,476 A dated Jan. 5, 1988 by Scott;

U.S. Pat. No. 4,750,999 A dated Jun. 14, 1988 by Roberts et al.;

U.S. Pat. No. 5,679,256 A dated Oct. 21, 1997 by Rose;

U.S. Pat. No. 5,820,762 A dated Oct. 13, 1998 by Bamer et al.;

U.S. Pat. No. 5,958,239 A dated Sep. 28, 1999 by Sing;

U.S. Pat. No. 5,993,672 A dated Nov. 30, 1999 by Manz;

U.S. Pat. No. 6,077,448 A dated Jun. 20, 2000 by Tran Quoc Nam et al.;

U.S. Pat. No. 6,123,858 A dated Sep. 26, 2000 by Manz;

U.S. Pat. No. 6,248,233 B1 dated Jun. 19, 2001 by Priggemeyer et al.;

U.S. Pat. No. 6,632,501 B2 dated Oct. 14, 2003 by Brownstein et al.;

U.S. Pat. No. 6,908,540 B2 dated Jun. 21, 2005 by Kholodenko;

U.S. Pat. No. 6,908,549 B2 dated Jun. 21, 2005 by Middleton et al.;

U.S. Pat. No. 7,005,060 a dated Feb. 28, 2006 by Pitt et al.;

U.S. Pat. No. 7,022,243 B2 dated Apr. 4, 2006 by Bryant;

U.S. Pat. No. 7,025,887 B1 dated Apr. 11, 2006 by Kirts et al.;

U.S. Pat. No. 7,300,590 B2 dated Nov. 27, 2007 by Weir et al.;

U.S. Pat. No. 7,459,090 B1 dated Dec. 2, 2008 by Collings;

U.S. Pat. No. 7,805,890 B2 dated Oct. 5, 2010 by Esmond et al.;

U.S. Pat. No. 7,892,425 B2 dated Feb. 22, 2011 by Generes et al.;

U.S. Pat. No. 7,892,425 B2 dated Feb. 22, 2011 by Generes et al.;

U.S. Pat. No. 8,002,974 B2 dated Aug. 23, 2011 by Noling et al.;

U.S. Pat. No. 8,002,984 B1 dated Aug. 23, 2011 by Wanielista et al.;

U.S. Pat. No. 8,012,346 B2 dated Sep. 6, 2011 by John Peters et al.;

U.S. Pat. No. 8,894,866 B1 dated Nov. 25, 2014 by Belasco;

U.S. Pat. No. 9,315,406 B2 dated Apr. 19, 2016 by Strano et al.;

US 2002/0096466 A1 dated Jul. 25, 2002 by Perry;

US 2008/0197083 A1 dated Aug. 21, 2008 by Raveneau Champion et al.;

US 2008/0217227 A1 dated Sep. 11, 2008 by Pank;

US 2008/0251448 A1 dated Oct. 16, 2008 by Kent;

US 2009/0101555 A1 dated Apr. 23, 2009 by Scarpine et al.;

US 2010/0326904 A1 dated Dec. 30, 2010 by Lord;

US 2013/0292317 A1 dated Nov. 7, 2013 by Shaw et al.;

US 2014/0021137 A1 dated Jan. 23, 2014 by Smiddy, et al.;

US 2017/0326478 A1 dated Nov. 16, 2017 by Noling et al.;

US 2017/0326478 A1 dated Nov. 16, 2017 by Noling et al.; and

WO 2017/205087 A1 dated Nov. 30, 2017 by NOLING et al.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a perspective view of a device configurable for treatment or pre-treatment of stormwater with the lid removed and the sides of the device partially cut-away to expose the interior;

FIG. 2A is a top view of a device configurable for treatment or pre-treatment of stormwater with the lid removed; FIG. 2B is a top view of a lid for a device according to the disclosure;

FIG. 3 is a top plan view of a device configurable for treatment or pre-treatment of stormwater;

FIGS. 4A-B are a side sectional view of a device along the lines 4-4 of FIG. 2A with and without media configurable for treatment or pre-treatment of stormwater;

FIG. 5 is a side sectional view through 5-5 in FIG. 2A;

FIG. 6 is a side sectional view through 6-6 in FIG. 2A; and

FIG. 7 is a flow diagram of a method for treatment or pre-treatment of stormwater using a disclosed device.

### DETAILED DESCRIPTION

Disclosed are coarse media filter devices and systems configurable to remove dirt, debris, oil and floatables by media filtration. The disclosed devices, systems and methods can be implemented as a stand-alone treatment device or as a pretreatment device in a treatment train configuration or as part of a system of unit operations. When installed as a pretreatment device, the devices prolong the maintenance interval and improve the function of any downstream treatment systems (e.g. sand or media filtration). The devices and systems are beneficial for sites with a high concentration of fine or non-settling solids in the stormwater. The systems are configurable to capture fine solids, particulate metals, neutral buoyancy debris, and floatable debris while also capturing hydrocarbons at a high flowrate.

I. Devices

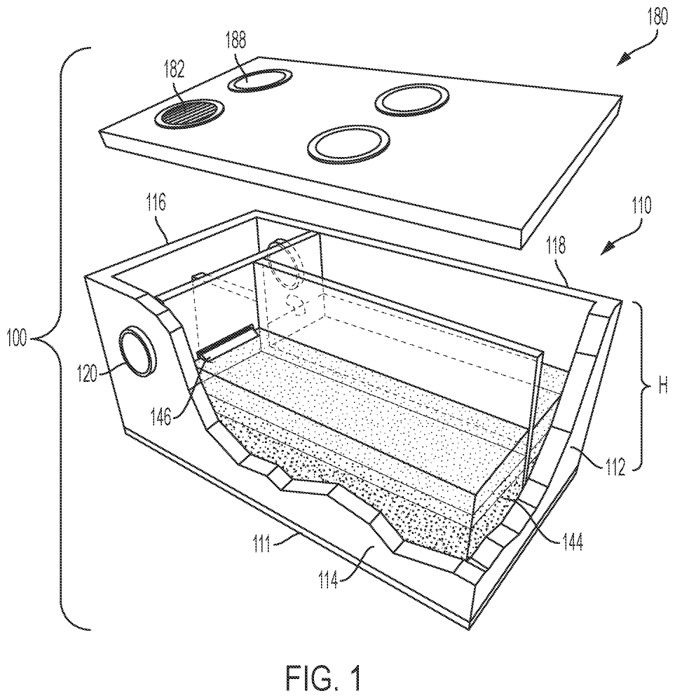

FIG. 1 is a perspective view of a device 100 configurable for treatment or pre-treatment of stormwater with a container 110 and a lid 180 removed. The container 110 has a bottom 111 and four exterior container side walls 112, 114, 116, 118. FIG. 1 illustrates two of the exterior container side walls, 112, 114 of the device 100 partially cut-away to expose the interior of the device 100 with interior portions of the device 100 shown in dashed lines to allow a perspective view into the various chambers. The overall shape of the device 100 can be a rectangular prism (as shown) or any other shape suitable to achieve the treatment results, e.g. cylindrical. The height H of the device 100 can vary to match the installation site conditions but is typically from 5 feet to 10 feet in height. The device 100 is configurable for installation below ground.

In use, water does not pass over the walls between the input chamber and the down-flow treatment chamber, the down-flow treatment chamber and the up-flow treatment chamber, or the up-flow treatment chamber and the output chamber. As discussed in more detail below the water passes from the input chamber to the down-flow treatment chamber via the aperture and shroud between input chamber 130 and down-flow treatment chamber 140, via the aperture formed by the wide transfer window 154 between down-flow treatment chamber 140 to and up-flow treatment chamber 150, and through the downturned elbow 152 between up-flow treatment chamber 150 and outflow chamber 160. Water can also pass over the top of the interior wall 132 between the input chamber 130 and the output chamber 160.

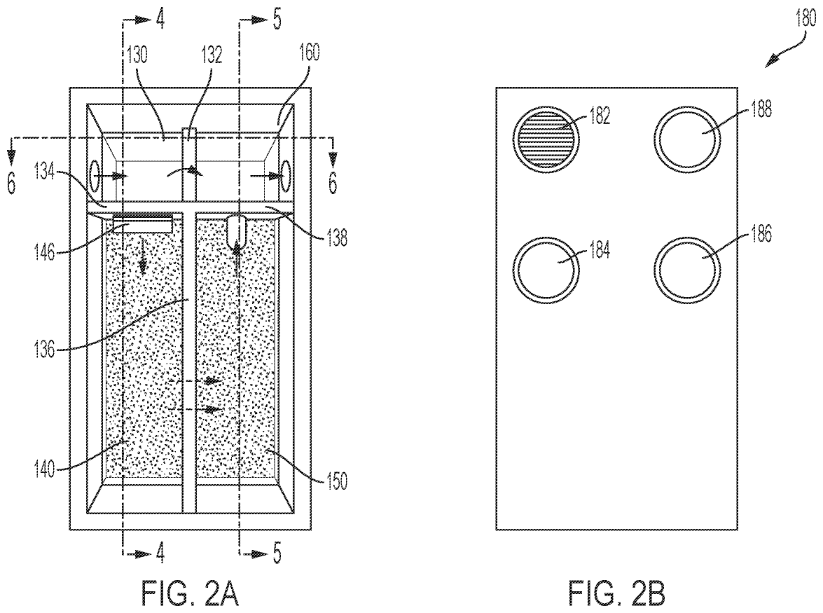

FIG. 2A is a plan view of a device 100 with four interior chambers: an inlet chamber 130, a down-flow treatment chamber 140, an up-flow treatment chamber 150, and an outlet chamber 160. Each chamber can be configured to be adjacent to two other chambers in the device 100 as shown.

In the illustrated embodiment, a first interior wall 132 is provided that is positioned between the inlet chamber 130 and the outlet chamber 160; a second interior wall 134 is provided that is positioned between the inlet chamber 130 and the down-flow treatment chamber 140; a third interior wall 136 is provided that is positioned between the down-flow treatment chamber 140 and the up-flow treatment chamber 150; and a fourth interior wall 138 is positioned between the up-flow chamber 150 and the outlet chamber 160. As will be appreciated by those skilled in the art, the interior walls can be separate walls and/or integrally formed walls without departing from the scope of the disclosure. For example, second interior wall 134 and fourth interior wall 138 can be formed from a single piece of material such as a single slab of concrete, plastic or steel.

Each chamber in the illustrated configuration has two chamber walls that correspond to a portion of two exterior walls of the device 100; and two chamber walls that are shared (i.e., a first interior wall shared with a first chamber and a second interior wall shared with a second chamber). A first exterior container side wall 112 borders the down-flow treatment chamber 140 and the up-flow treatment chamber 150. A second exterior container side wall 114 borders the down-flow treatment chamber 140 and the inlet chamber 130. A third exterior side wall 116 borders the inlet chamber 130 and the outlet chamber 160. A fourth exterior wall 118 borders the up-flow treatment chamber 150 and the outlet chamber 160.

As will be appreciated by those skilled in the art, the actual location of the inlet chamber 130 and the outlet chamber 160 in any configuration is a function of the direction of stormwater flow for a particular installation and not limited to the position illustrated in the figures. The inlet chamber 130 has an inlet aperture and the outlet chamber has an outlet aperture. As illustrated, the inlet aperture is shown with an inlet pipe 120 and the outlet aperture is shown with an outlet pipe 122. Additionally, the inlet pipe 120 can be positioned on any exterior surface corresponding to the inlet chamber 130 and the outlet pipe 122 can be positioned on any exterior surface corresponding to the outlet chamber 160 without departing from the scope of the disclosure. Thus, for example, the inlet pipe 120 and the outlet pipe 122 could be positioned on the exterior wall 116 corresponding to the inlet chamber 130 and the outlet chamber 160.

The device 100 has an inlet pipe 120 on the second exterior container side wall 114. The inlet pipe 120 is, for example, a 4″ cast-in inlet coupling which is watertight around the coupling edges. The inlet pipe 120 is positionable between 50-70% of the height from the bottom of the device 100. Inlet chamber 130 receives stormwater runoff through inlet aperture via the illustrated inlet pipe 120 and/or an inlet grate 182 in the lid 180.

A first interior wall 132 is positioned between the inlet chamber 130 and the outlet chamber 160. The first interior wall 132 is a weir wall. The first interior wall 132 has a variable height that is determined based on bypass flow rates and calculated head-loss through the system. As illustrated, the height is approximately 83% of the total exterior height of the device 100. The first interior wall 132 can function as an internal high-flow bypass.

A second interior wall 134 is positioned between the inlet chamber 130 and the down-flow treatment chamber 140. The second interior wall 134 can be any height above the water surface and all the way to the bottom surface of the lid 180. As illustrated, the second interior wall 134 is shown with a height that is approximately 83% of the total exterior height of the device 100. The down-flow treatment chamber 140 is configured to receive stormwater from the inlet chamber 130.

The stormwater to be treated is received into the inlet chamber 130 and then directed into the second chamber or down-flow treatment chamber 140. An aperture 143 is provided in the second interior wall 134. The aperture 145 has a shroud 146 was positioned above the upper surface of the aperture 145. The shroud 146 can be formed from stainless steel, plastic or other material, and positioned to direct the flow of water through the aperture 143 from the inlet chamber 130 to the down-flow treatment chamber 140 in a downward gradient. The use of the shroud 146 to achieve a downward gradient sweeps debris under the shroud 146 but prevents captured floating debris from escaping during a high-flow bypass event. In the down-flow treatment chamber 140, coarse debris and trash are removed from the stormwater by mechanical filtration and floatation. Flow capacity and treatment performance are maximized by the large irregular pore spaces of the coarse media, the low water velocity through the media, and the relatively high surface area available for solids adhesion.

As will be appreciated by those skilled in the art, a high-flow bypass event occurs during extreme events when the amount of water attempting to pass through the system exceeds a threshold potentially causing re-suspension of sediment. In order to minimize the negative impact of an extreme event on the operation of the system, the first interior wall 132 allows excess water to be shunted directly to the output container to avoid re-suspension of sediment thereby increasing the overall effectiveness of the pollutant removal process.

The down-flow treatment chamber 140 includes coarse filtration media 144. The down-flow treatment chamber 140 is characterized by a filter media depth and a water depth. As will be appreciated from the figures, the down-flow treatment chamber 140 has a relatively shallow filter bed depth. The wide shallow bed of the down-flow treatment chamber 140 allows a large flow rate of stormwater to pass through the filter with little pressure or head-loss.

Water from the down-flow treatment chamber 140 passes to the up-flow treatment chamber 150. The up-flow treatment chamber 150 has a filter media depth and a water depth. A wide transfer window 154 is formed by an aperture in the third interior wall 136 having a wide transfer window width and height. The wide transfer window 154 is positioned between the down-flow chamber 140 and the up-flow chamber 150 and provides for fluid communication between the two chambers. The wide transfer window 154 allows for a well-distributed flow throughout the filter media and reduces the amount of hydraulic pressure required to force the water through the filter. The wide transfer window 154 can be formed by a baffle wall blockout or opening created in the wall. The wide transfer window 154 has a width that is about >75% of the width of the third interior wall 136 and a height that is about 30-40% of the height from the floor to the invert of the outlet orifice elbow 152. The wide transfer window 154 is positioned along a portion of the third interior wall 136 below an upper surface of filter material placed into the down-flow treatment chamber 140 and up-flow treatment chamber 150. In some configurations, the wide transfer window 154 is positioned at or near the bottom surface of the third interior wall 136. The devices can be formed from any suitable material including, but not limited to, concrete, steel, fiberglass, or plastic. The up-flow treatment chamber 150 is a second coarse media filtration chamber that allows for additional pollutant removal through mechanical filtration, media surface adhesion and coalescing of oily substances that allows floatable oil droplets and particulates to agglomerate and become trapped or float to the surface. The outlet orifice elbow 152 controls the flowrate through the treatment chambers and retains floatables and hydrocarbons within the treatment chamber (i.e., does not allow floatables to pass to the outlet chamber 160).

As will be appreciated by those skilled in the art, one or more layers of filter material can be used for the filter media 144 and the height of the media in the down-flow chamber 140 and the up-flow chamber 150 can be the same or substantially the same.

Table 1 provides exemplar dimensions for various components of the devices.

TABLE 1
Exemplar Part Sizes

| | Size Range | |
|---|---|---|
| Component | (Feet) | |
| Device Length | 9 | 28 |
| Device Width | 7 | 11 |
| Device Height | 5 | 15 |
| Inlet Chamber: Down-Flow Chamber wall (134) height | 5 | 10 |
| Inlet Chamber: Outlet Chamber wall (132) height | 3.5 | 9 |
| Inlet Window (145) width | 2 | 5 |
| Inlet Window (145) height | 0.5 | 1 |
| Shroud (146) width | 2 | 5 |
| Down-Flow Chamber: Up-Flow Chamber wall (136) | 5 | 10 |
| Down-flow Chamber Depth | 5 | 10 |
| Down-flow Chamber Filter Media Depth | 2 | 4 |
| Down-flow Chamber water depth | 3 | 5 |
| Wide transfer window (154) width | 2 | 21 |
| Wide transfer window (154) height | 1 | 2 |
| Up-flow chamber: outlet chamber (138) wall height | 5 | 10 |

As will be appreciated by those skilled in the art, the overall size of the devices is configurable to match the site conditions. For example, the depth can be a variable depth as needed based on the site.

The lid 180 has a plurality of apertures. One or more of the apertures can function as hatch openings for accessing an interior of the device 100. Each hatch opening can have a cover or door. A first aperture can be configured to receive a grate inlet 182 positioned on the lid 180 in a location over the inlet chamber 130 when the lid 180 is positioned over the container 110. A second aperture 184 can be provided and positioned on the lid 180 in a location over the down-flow chamber 140 when the lid 180 is positioned over the container 110. A third aperture 186 can be provided and positioned on the lid 180 in a location over the up-flow chamber 150 when the lid 180 is positioned over the container 110. A fourth aperture 188 can be provided and positioned on the lid 180 in a location over the outlet chamber 160 when the lid 180 is positioned over the container 110. The apertures are illustrated as circular, but as will be appreciated by those skilled in the art, the apertures do not need to have the same shape or size. For example, one or more of the apertures and corresponding covers can be square. Each of the apertures can be configured to receive a grate or cover. Typically, the grate is associated with the aperture over the inlet chamber 130, and the covers are associated with the apertures over the remaining chambers. Additionally a riser can be provided to increase the bury depth of container 110 and to increase the distance from ground surface to 180?

FIG. 2 is a top view of a device 100 configurable for treatment or pre-treatment of stormwater with the lid removed.

The inlet chamber 130 and the outlet chamber 160 have an interior length that is, for example, about 20% the overall exterior length L of the device 100 and an interior width of about 44% the overall exterior width W of the device 100. The down-flow treatment chamber 140 and the up-flow treatment chamber 150 has an interior length that is about 76% of the overall exterior length L of the device 100 and an interior width of about 44% of the overall exterior width W of the device 100. Other ratios can be used without departing from the scope of the disclosure.

The length and the width of the outlet chamber 160 can be the same or substantially the same as the inlet chamber 130. The length and the width of the up-flow treatment chamber 150 can be the same or substantially the same as the down-flow treatment chamber 140.

As discussed above, inlet chamber 130 receives stormwater runoff through the inlet pipe 120 and/or an inlet grate 182 in the lid 180. The water then passes from the inlet chamber 130 to the down-flow treatment chamber 140. Some stormwater may pass from the inlet chamber 130 to the outlet chamber 160 by passing over the first interior wall 132 which is sized to act as an internal high-flow bypass between the inlet chamber 130 and the outlet chamber 160, and around the down-flow treatment chamber 140 and up-flow treatment chamber 150. For storm conditions that exceed the design treatment flow rate that passes through the down-flow treatment chamber 140 and up-flow treatment chamber 150, the systems and devices are configurable to allow a portion of the stormwater to move directly from the inlet chamber 130 to the outlet chamber 160 by flowing over the first interior wall 132 which functions as a bypass weir wall by allowing water to pool behind the wall and flow over the top of the wall during the storm conditions that exceed design parameters.

Coarse debris and trash are removed from the stormwater by mechanical filtration and floatation in the down-flow treatment chamber 140. Flow capacity and treatment performance are maximized by the large pore spaces of the coarse media, low water velocity through the media pore spaces, and the relatively high surface area available for solids adhesion. Stormwater then passes to the up-flow treatment chamber 150 via the wide transfer window 154 which allows for a well-distributed flow throughout the filter media and reduces the amount of hydraulic pressure required to force the water through the filter. The well-distributed flow eliminates the occurrence of high-velocity zones that would scour the filter media.

The up-flow treatment chamber 150 is the second coarse media filtration chamber that allows for additional pollutant removal through mechanical filtration, media surface adhesion, and coalescing of oily substances that allows fine floatable oil and hydrocarbon droplets and particulates to agglomerate and become trapped or float to the surface. The adsorbed oily particulates act as a fixed film biological reactor to remove and degrade organics. The outlet orifice elbow 152 in this chamber serves to control the flow rate through the treatment chambers and retain floatables within the device 100.

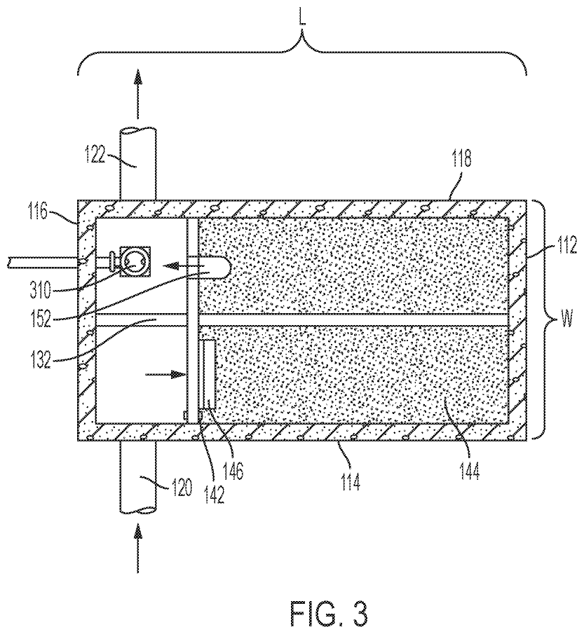

FIG. 3 is a top plan view of a device 100 configurable for treatment or pre-treatment of stormwater. From this view, the flow of the stormwater from the inlet chamber 130 to the downflow chamber 140 to the upflow chamber 150 and finally the outlet chamber 160 via the outlet orifice elbow 152. An outlet pipe 122 is provided that allows the treated stormwater to pass out of the outlet chamber 160. The water exiting the outlet chamber 160 is discharged by gravity through the outlet pipe 160.

A submersible pump system 310 can be provided which facilitates pumping the pre-treated processed stormwater out of the outlet chamber 160 for additional treatment or reuse above-ground. The pump sits in the bottom of the outlet chamber 160 and lifts the pre-treated stormwater through a pressurized discharge pipe to a downstream use.

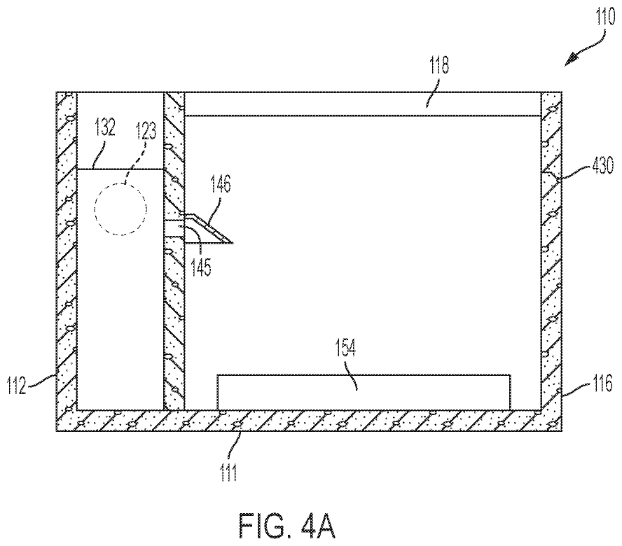

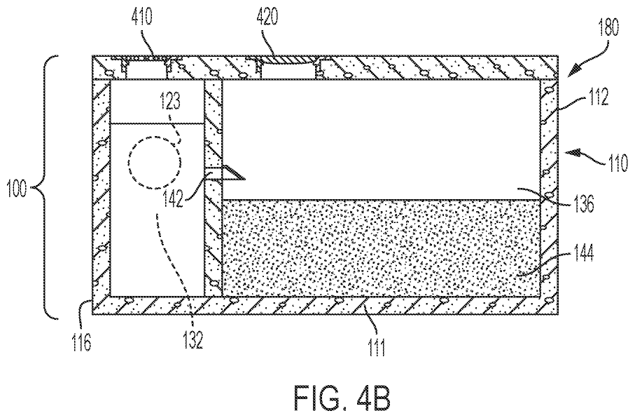

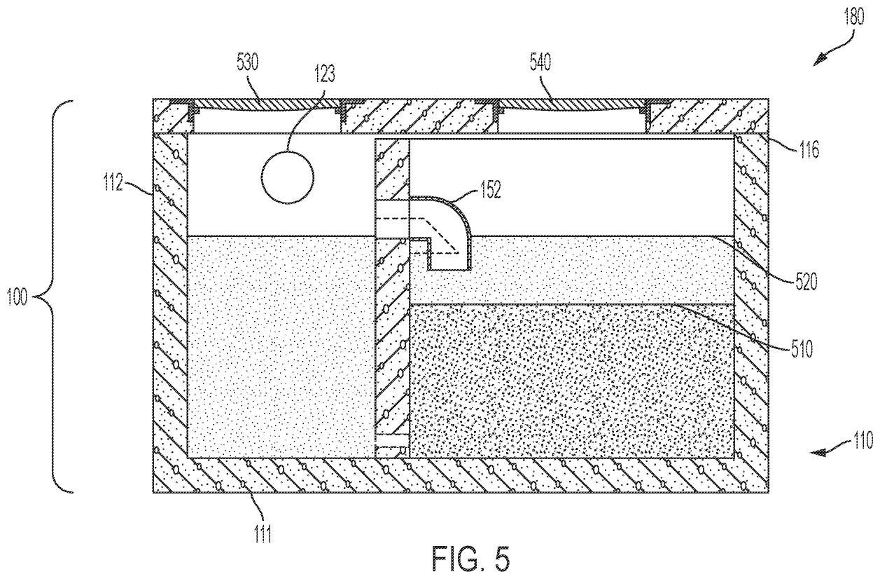

FIGS. 4A-B are a side sectional views of a device 100 configurable for treatment or pre-treatment of stormwater. Two removable covers 410, 420 are depicted in FIG. 4B. The covers 410, 420 can be sized to provide access to the interior of the device 100 during maintenance. A suitable size for the manhole aperture is 24″ with the covers 410, 420 sized to fit over the manhole apertures. As discussed above, other shapes and for the apertures (shown as, for example, 184, 186, 188 in FIG. 2B) and covers 420 (shown in FIG. 4) and 530, 540 (shown in FIG. 5), such as rectangular, can be used without departing from the scope of the disclosure. Risers (not shown) can also be provided to raise the access point to grade. Risers would have a two-dimensional shape corresponding to the aperture (e.g., round or rectangular). A key-way groove (not shown) can also be provided to help seal the two pieces of the device 100 where the two pieces come together. The outlet aperture 123 can be connected to, for example, an outlet pipe 122.

FIG. 5 is a side sectional view of the device 100 through the outlet chamber 160 and the up-flow treatment chamber 150 through the lines 5-5 in FIG. 2A. The media surface 510 is shown below the water surface 520.

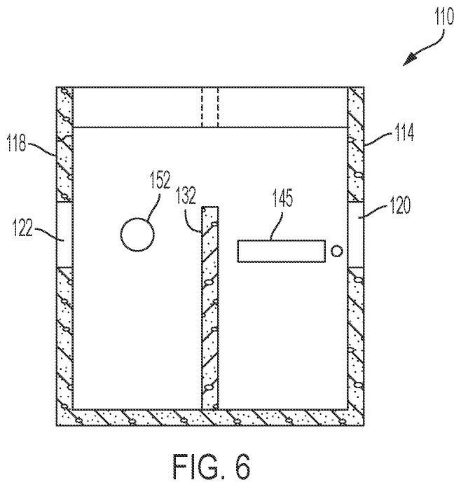

FIG. 6 is a side sectional view of the device 100 through the inlet chamber 130 and the outlet chamber 160 along the lines 6-6 in FIG. 2A.

II. Methods

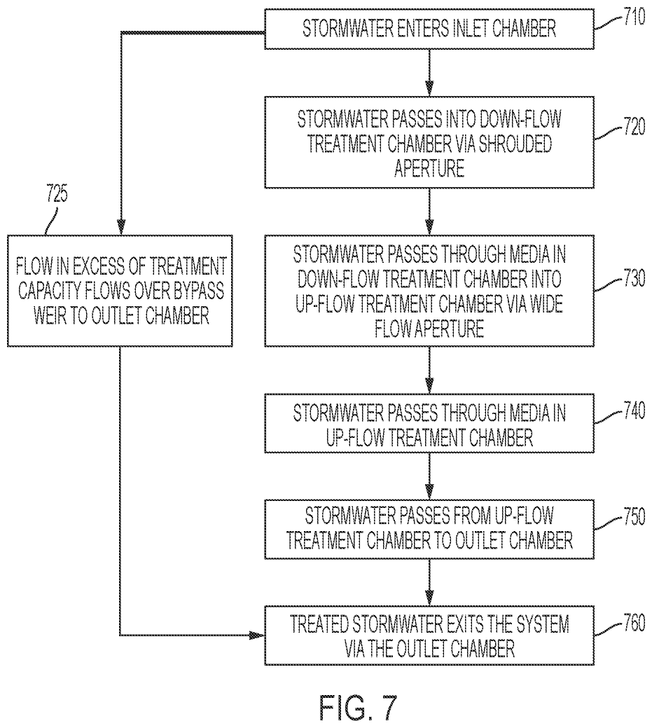

FIG. 7 is a flow diagram of a method for treatment or pre-treatment of stormwater using a disclosed device. The systems and devices are typically installed below ground and in-line with an existing storm drain to allow stormwater to be gravity fed into the systems and devices.

Stormwater is gravity fed through the inlet pipe 120 and/or the grate inlet 182 in the lid 180 into the inlet chamber 130 as shown at step 710. Once the stormwater level reaches a target height within the inlet chamber 130 determined by the invert elevation of 152 plus the head-loss through chambers 140 and 150, stormwater passes through the inlet window 145 in the interior wall between the inlet chamber 130 and the down-flow treatment chamber 140 at step 720. The stormwater passes into the down-flow treatment chamber 140 on a downward gradient from the inlet chamber 130. Stormwater then collects on the surface of the media in the down-flow treatment chamber 140. As additional stormwater collects in the downward flow chamber 140, water is forced into the media material until the stormwater reaches or substantially reaches the bottom of the down-flow treatment chamber 140. Over time, the stormwater passes laterally from the down-flow treatment chamber 140 into the adjacent up-flow treatment chamber 150 via the wide-flow transfer window 154 located between the two treatment chambers. As stormwater passes into the up-flow treatment chamber 150 and the stormwater passes through the filter media in the up-flow treatment chamber 150 until it passes to the surface of the filter media in the up-flow treatment chamber 150. From the upper filter media surface, the stormwater (now filtered through the media in the down-flow treatment chamber 140 and the media in the up-flow filter treatment chamber 150) collects until it passes into the outlet chamber 160. From the outlet chamber 160, the treated or pretreated stormwater passes via gravity through an outlet 170. Once the treated stormwater exits the device it can be transferred to another treatment system for further processing or to a stormwater outfall or discharge location. Additionally, a pump system can be provided which is associated with the outlet chamber. The pump system can be used to facilitate pumping treated or pretreated stormwater from the device.

Flow in excess of treatment capacity can also flow over the internal wall 132 (the bypass weir) directly to the outlet chamber 725 before exiting the system via the outlet chamber 760.

The devices are configurable to achieve the treatment rates outlined in Table 2.

TABLE 2
TREATMENT RATES

| Treatment Rate | Footprint | Sediment | Oil/Floatable |
|---|---|---|---|
| (gpm) gallons | (L × W) | Capacity | Storage |
| per minute | in feet | (cubic yards) | (gallons) |
| 160 | 7 × 9 | 0.5 | 100 |
| 300 | 7 × 13 | 1.0 | 180 |
| 480 | 8 × 16 | 2.1 | 280 |
| 600 | 9 × 17 | 2.6 | 360 |
| 760 | 11 × 17 | 4.2 | 460 |
| 1400 | 11 × 28 | 7.5 | 810 |

Polluted stormwater is directed to the two media chambers in series for removal of dirt, debris, oil and floatables, and other associated pollutants such as heavy metals, nutrients and organics. Treated stormwater flows to the outlet chamber for discharge. With the built-in internal high flow bypass, pollutants are trapped in the treatment chambers in below ground installations even during excessive runoff events or events exceeding the design capacity of the device.

Table 3 provides performance rates for removal efficiency of pollutants

TABLE 3
POLLUTANT REMOVAL EFFICIENCY

| | Removal |
|---|---|
| Pollutant | Efficiency |
| Total suspended solids (TSS) | 50-70% |
| Aluminum | 30-60% |
| Copper | 40-70% |
| Iron | 40-60% |
| Zinc | 10-30% |

Monitoring the operational condition of the devices and systems can be achieved by periodic sampling of the filtration media from either treatment chamber using a long-handled swing sampler. The solid to media ratio is evaluated to determine the condition of filter media and remaining pollutant removal capacity. As the ratio increases, the media is more occluded and is not filtering as efficiently. Once the ratio is increased beyond an optimal amount, the filter media can be changed. The media, sediment and water removed from the systems and devices are disposed of in accordance with applicable waste disposal regulations.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed:

1. A filtration system comprising a flow container wherein the flow container comprises:
an inlet chamber in fluid communication with a fluid inlet aperture;
a first media filtration chamber in fluid communication with the inlet chamber having a first media;
a flow structure positioned between the inlet chamber and the first media filtration chamber wherein the flow structure is configured to direct fluid passing from the inlet chamber to the first media filtration chamber in a downward direction;
a second media filtration chamber in fluid communication with the first media filtration chamber having a second media wherein the second media filtration chamber has an upward treatment flow direction;
a wide flow transfer window positioned between the first media filtration chamber and the second media filtration chamber wherein the wide flow transfer window allows continuous filtration between the first media filtration chamber and the second media filtration chamber;
an outlet chamber in fluid communication with the second media filtration chamber; and
an outlet aperture in fluid communication with the outlet chamber.

2. The filtration system of claim 1 wherein the inlet chamber is further in fluid communication with the outlet chamber via an internal high-flow bypass.

3. The filtration system of claim 1 wherein the first media and the second media are the same media material.

4. The filtration system of claim 1 wherein a position of the flow structure between the inlet chamber and the first media filtration chamber is positioned above an upper level of the media layer.

5. The filtration system of claim 1 wherein a position of the wide flow transfer window between the first media filtration chamber and the second media filtration chamber is positioned below an upper level of the media layer in the first media filtration chamber.

6. The filtration system of claim 1 wherein the filtration system is positioned in series with a second treatment device.

7. The filtration system of claim 6 wherein the filtration system is a pre-treatment system.

8. The filtration system of claim 6 wherein the filtration system is a secondary treatment system.

9. The filtration system of claim 1 wherein the filtration system has a pollutant removal efficiency of at least one of: TSS 50-70%; Aluminum 30-60%; Copper 40-70%; Iron 40-60%; and Zinc 10-30%.

10. The filtration system of claim 1 wherein the filtration system has a treatment rate of from 160 gallons-per-minute to 1,400 gallons-per-minute.

11. A method of treating fluid comprising the steps of:
providing a source fluid for treatment to an inlet chamber via at least one of a lateral inlet aperture and an upper aperture;
transferring the fluid received into the inlet chamber to a first media filtration chamber via a flow structure positioned between the inlet chamber and the first media filtration chamber wherein the flow structure is configured to direct fluid passing from the inlet chamber to the first media filtration chamber in a downward direction;
passing the fluid received into the first media filtration chamber through a first media layer;
passing the fluid via a wide flow transfer window through a second media layer in a second media filtration chamber;
receiving the fluid onto a surface of the second media layer; and
passing fluid into an outlet chamber in fluid communication with the second media filtration chamber; and
delivering fluid from the outlet chamber via an outlet aperture.

12. The method of treating fluid of claim 11 further wherein the fluid received to the inlet chamber is gravity fed.

13. The method of treating fluid of claim 11 further comprising the step of passing the fluid from the inlet chamber to the outlet chamber when a fluid level exceeds a holding volume in the inlet chamber.

14. The method of treating fluid of claim 11 wherein first media layer and the second media layer comprise the same media material.

15. The method of treating fluid of claim 11 wherein first media layer and the second media layer comprise the different media material.

16. The method of treating fluid of claim 11 further comprising the step of removing pollutants from the fluid through one or more of mechanical filtration, media surface adhesion, and coalescing of oily substances.

17. The method of treating fluid of claim 11 further comprising the step of passing the fluid through the media using a high surface area and low fluid velocity.

18. The method of treating fluid of claim 11 wherein the filtration system has a pollutant removal efficiency of at least one of: TSS 50-70%; Aluminum 30-60%; Copper 40-70%; Iron 40-60%; and Zinc 10-30%.

19. The method of treating fluid of claim 11 wherein the filtration system is configured to treat 160 to 1400 gallons per minute.

20. The method of treating fluid of claim 11 where the fluid contains solid materials and particulate materials.
